(19) United States
(12) Patent Application Publication
(10) Pub. No.: US 2005/0254923 A1
(43) Pub. Date: Nov. 17, 2005

(54) High lift wheel dolly method and apparatus

(75) Inventors: Tim Gorski, Owatonna, MN (US); Rodd Joos, Lauderdale, MN (US)

Correspondence Address: BAKER & HOSTETLER LLP;Washington Square, Suite 1100, 1050 Connecticut Avenue, N.W., WASHINGTON, DC, 20036, US

(73) Assignee: SPX Corporation

(21) Appl. No.: 10/844,407

(22) Filed: May 13, 2004

(51) Int. Cl. B65G 7/00

(52) U.S. Cl. 414/426

(57) ABSTRACT

A high lift wheel dolly includes a method and apparatus for supporting and lifting components. The invention includes a main frame assembly, a lift carriage connected to the main frame assembly, and a hydraulic cylinder and ram assembly located on the main frame assembly and further coupled to the lift carriage. The lift carriage is pivotably connected to the main frame assembly and can further provide lateral movement with respect to the main frame assembly.

### FIELD OF THE INVENTION

The present invention relates generally to vehicle servicing equipment and method of use. More particularly, the present invention relates to high lift wheel dollies for servicing vehicles in the heavy-duty truck service industry.

### BACKGROUND OF THE INVENTION

Many commercial vehicles used for commercial trucking, transportation, and the like require large, bulky, and heavy wheels. After a period of use, wheels and/or associated components of large commercial vehicles may require maintenance and repair. Because of the size, weight, and confined space in which a mechanic may work, handling of such wheels to maneuver into a convenient orientation can be strenuous or could run a risk of imposing difficulty to a mechanic.

Typically, when removing large vehicle wheels, a mechanic will use a jack to jack up the vehicle and the selected wheel to be removed off the ground. Alternatively, the entire vehicle may be lifted a limited distance off the ground. The mechanic will thereafter slide a conventional wheel dolly under the wheel. Conventional wheel dollies typically carry a wheel cradle which can be vertically raised a limited distance to engage and support the wheel during its dismounting, for the vehicle. The wheel dolly can also be vertically raised to engage and support the wheel during work such as assembly or disassembly of the wheel itself. After the wheel has been removed from the vehicle, the dolly carrying the wheel may be rolled away in order for a mechanic to gain access to the wheel hub and associated components.

Conventional wheel dollies are typically restricted to only limited vertical lifting capability to assist the mechanic in positioning the wheel or wheel components for repair. A dolly having only limited vertical lifting capability requires a mechanic, in many instances, to crouch or bend over to have access to the wheel in order to remove it or assemble it to its associated components. This may require the mechanic to conform to contorted, stooped, or bent positions while working. These positions can contribute to fatigue and/or injury stemming from exerting force, for example, from an anatomically awkward position. For wheel dollies having only limited vertical lifting capability, a mechanic may need to compensate for servicing a wheel at an additional height form the dolly itself. This task can waste valuable service time and also impose a challenge for either distributing the wheel a distance from the wheel hub assembly to the dolly, or positioning the wheel from the dolly onto its respective wheel hub assembly.

Accordingly, it is desirable to provide a method and apparatus that provides a power assisted wheel dolly capable of lifting a wheel including, for example, extended distances to support it during assembly and removal operations. It is further desirable to provide a method and apparatus for tilting the wheel back into an inclined position to give improved accessibility to the wheel and its components while alleviating the necessity for a mechanic to work in contorted or uncomfortable positions. It is further desirable to provide a method and apparatus for providing lateral movement to the wheel and its associated components in order to provide lateral movement to the wheel in order to give improved accessibility to the wheel and its components while enhancing aligning capabilities of the dolly, for instance, to service the wheel.

### SUMMARY OF THE INVENTION

The foregoing needs are met, to a great extent, by the present invention, wherein in one aspect an apparatus is provided that in some embodiments comprises a main frame assembly, a lift carriage slidably converted to the main frame assembly. The lift carriage may be laterally adjustable with respect to the main frame assembly. The apparatus may further provide a hydraulic cylinder and ram assembly located or the main frame assembly and be further coupled to the lift carriage.

In accordance with another aspect of the present invention, a method is provided that in some embodiments provides a hydraulic cylinder and ram assembly on a main frame assembly. A lift carriage for supporting a component is also provided. The method may further include pivotally correcting the lift carriage to the main frame assembly and coupling the hydraulic cylinder and ram assembly to the lift carriage.

In accordance with yet another aspect of the present invention, a system is provided that in some embodiments comprises a means for supporting a component, a means for tilting the supporting means, a means for providing lateral movement to the supporting means, a means for lifting the supporting means, and a means for supporting the lifting means.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a perspective view illustrating a high-lift wheel dolly according to a preferred embodiment of the invention.

FIG. 2 is a front view of the preferred embodiment of the invention shown in FIG. 1.

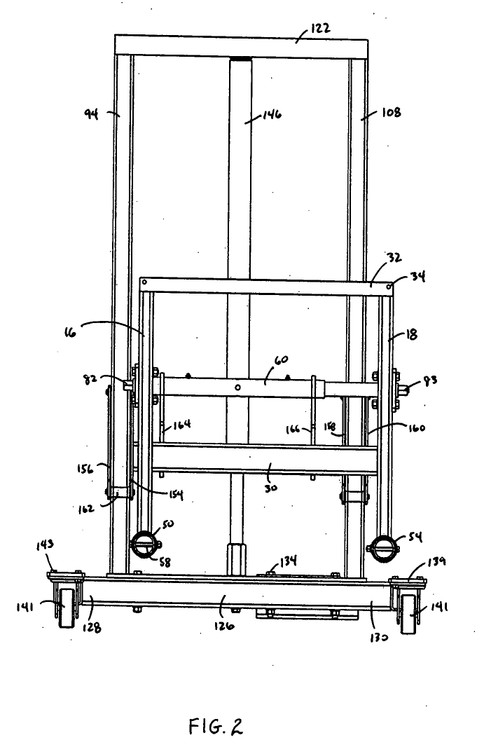

FIG. 3 illustrates an interior view of a shaft tube according to a preferred embodiment of the invention.

FIG. 4 is a perspective view illustrating a high-lift wheel dolly supporting a duplex tire according to a preferred embodiment of the invention.

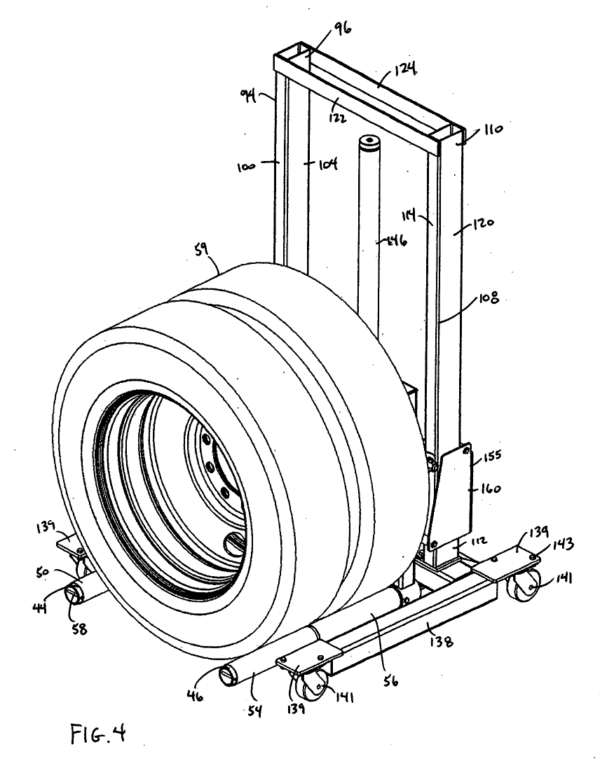

FIG. 5. is a side view of a high-lift wheel dolly supporting a duplex tire according to a preferred embodiment of the invention.

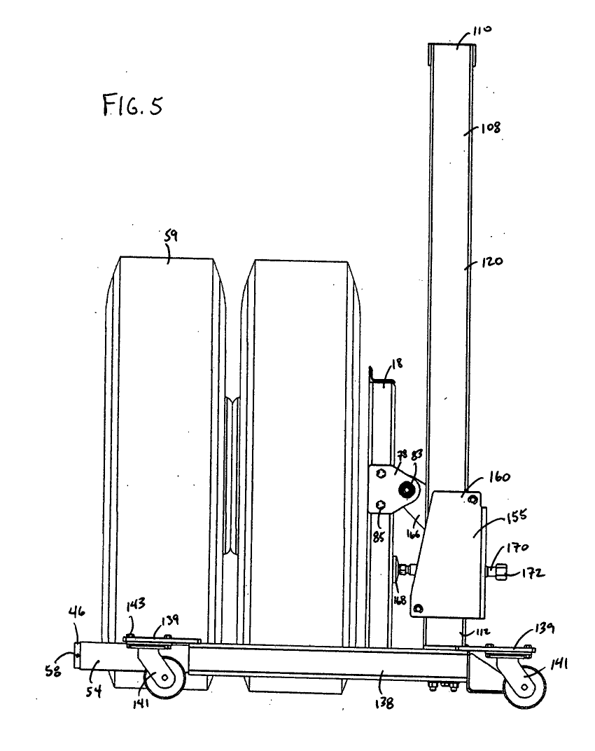

FIG. 6. is a rear view of a high-lift wheel dolly supporting a duplex tire according to a preferred embodiment of the invention.

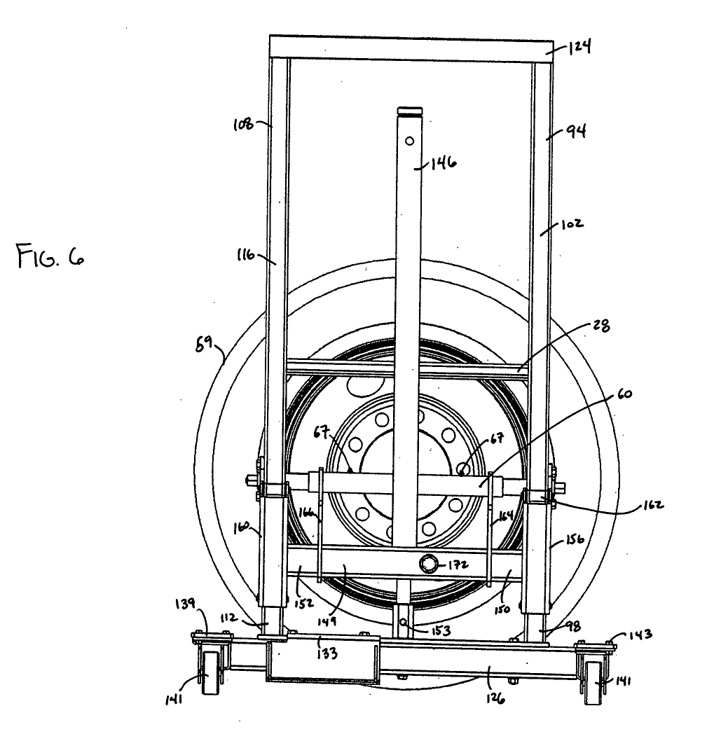

FIG. 7 is perspective view illustrating a high-lift wheel dolly supporting a duplex tire in a raised position.

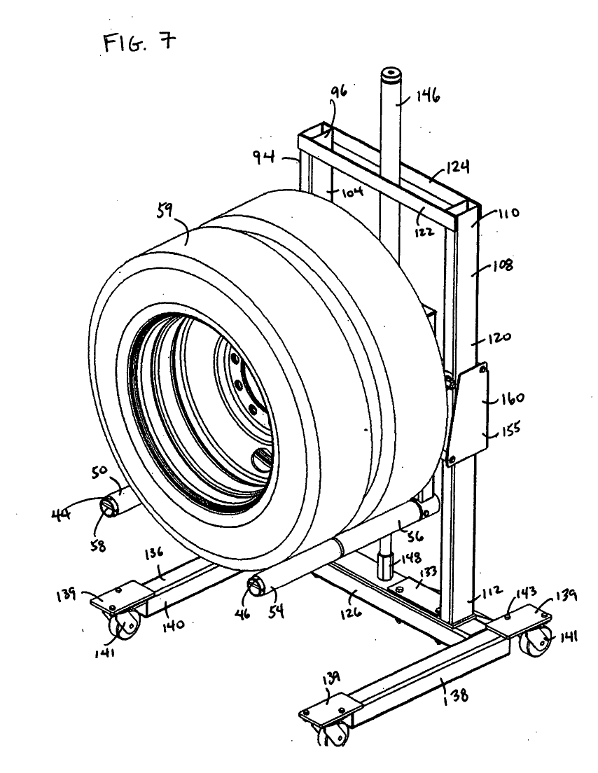

### DETAILED DESCRIPTION

An embodiment in accordance with the present invention provides a high lift wheel dolly which features receiving and lifting loads over extended distances to service vehicles. Another embodiment in accordance with the present invention provides a configuration of a high lift wheel dolly having a tilting feature. Another embodiment in accordance with the present invention provides a configuration of a high lift wheel dolly having a feature to provide lateral movement to a supported load. Preferred embodiments of the invention will now be described with reference to the drawing figures, in which like reference numerals refer to like parts throughout.

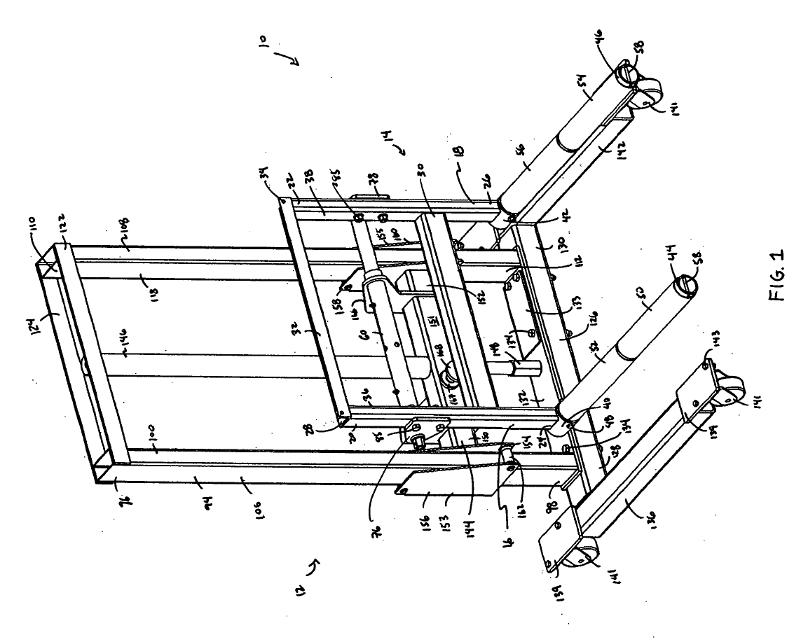

An embodiment of the present inventive apparatus is illustrated in FIG. 1 wherein a high lift wheel dolly 10 is shown. In the preferred embodiment, the high lift wheel dolly 10 may generally include a main frame assembly 12 which preferably supports a lift carriage 14. A purpose of the lift carriage 14 includes providing support to a load, such as a tire, including, for example, a duplex tire for class 6, 7, and 8 trucks during an assembly or removal operation of the tire to or from the vehicle. The lift carriage 14 is further preferably designed to accommodate movement in a vertical, lateral, and/or an angular direction based upon the need of an operator to adjust/align the wheel accordingly.

In a preferred embodiment, the lift carriage 14 may generally comprise a rearward frame support assembly comprising various weldable steel members. The steel members may include a left vertical support member 16 and a right vertical support member 18, wherein each vertical support member 16, 18 has a respective top end 20, 22 and bottom end 24, 26. Left vertical support member 16 and right vertical support member 18 are preferably designed in a rectangular design to not only provide adequate support to the frame support assembly, but to mountably receive additional components. Additional members of the frame support assembly may further include a top cross bar member 28 and a bottom cross bar member 30, with each member 28, 30 having two ends.

The ends of the top cross bar member are preferably joined to the top ends 20, 22 of the left vertical support member 16 and a right vertical support member 18, respectively. In a preferred embodiment, the top cross bar member 28 comprises a flange portion 32 which creates an L-shape design. The flange portion preferably contains two holes 34 for receiving attachment hooks, such as S-hooks, which may be further connected to a chain to secure the tire thereto.

Bottom cross bar member 30 is preferably designed in a rectangular fashion to provide adequate support to the frame support assembly. In a preferred embodiment, the bottom cross bar member 30 is weldably attached to an inner side surface 36 of the left vertical support member 16 and an inner side surface 38 of the right vertical support member 18.

The bottom ends 24, 26 of the left vertical support member 16 and the right vertical support member 18 are affixed to left fork post holding member 40 and right fork post holding member 42, respectively, in a preferably weldable fashion. The fork post holding members 40, 42 respectively retain left fork post member 44 and right fork post member 46. An end of the left fork post member 44 and right fork post member 46 may be respectively inserted into fork post holding members 40, 42 and retained therein via fasteners such as, for example, bolt and nut assembly 48.

In a preferred design, the left fork post member 44 and right fork post member 46 may be lubricated by grease, for example. A single or plurality of sleeves such as steel sleeves 50, 52, 54, 56 may be further inserted over the greased post members 44, 46 and retained thereon by a fastening member such as by pin member 58. The assembly, as described herein, facilitates rotational movement of a tire 59 supported on the steel sleeves 50, 52, 54, 56 as may be deemed necessary by a mechanic. In a preferred operation environment, a duplex or dual tire wheel assembly is utilized and supported by the steel sleeves 50, 52, 54, 56 of the high lift wheel dolly 10.

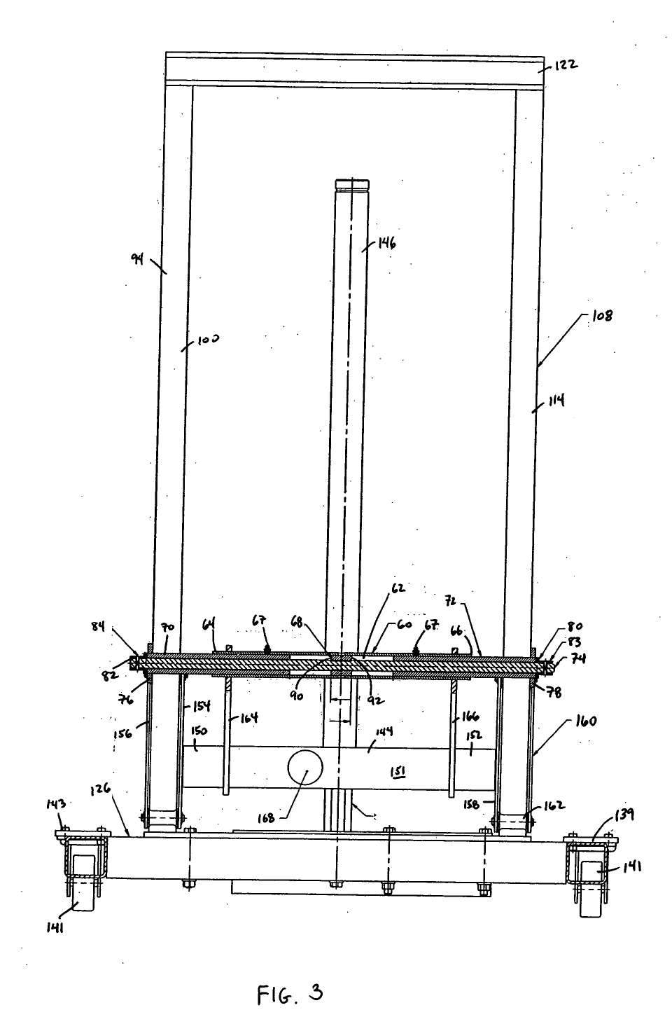

A discussion of a preferred embodiment describing how the lift carriage 14 is connected to the main frame assembly 12 is now provided. A shaft tube 60 is coupled to the lift carriage 14, which shaft tube 60 is further coupled to the main frame assembly 12. FIG. 3 illustrates the shaft tube 60 having an interior portion 62, left end 64, and right end 66. Grease fittings 67 may be located on the shaft tube 60 in order to provide lubrication to an inner diameter thereof either during assembly or once assembled. A threaded plug 68 is located with the interior portion 62 and retained therein preferably by weldment generally around the center of the shaft tube 60. Left hollow shaft member 70 and right hollow shaft member 72 are inserted into the interior portion 62 at the left end 64 and right end 66, respectively, of the shaft tube 60.

Left retaining plate 76 and a right retaining plate 78 are provided to couple the shaft tube 60, left hollow shaft member 70, and right hollow shaft member 72 to the lift carriage 14. A threaded rod 74 is provided with a configuration in length preferably long enough to traverse a general length of the assembled components of the left hollow shaft member 70, the middle of the shaft tube 60, the threaded plug 68, the right hollow shaft member 72, and the right retaining plate 78. Additionally, a small portion of the threaded rod 74 extends past the left retaining plate 76 and the right retaining plate 78 to accommodate a thrust bearing 80 and nuts 82, 83 at each end thereof. The left retaining plate 76 and a right retaining plate 78 may be further secured to the left vertical support member 16 and the right vertical support member 18 via sufficient fasteners such as threaded bolt and lock nut assemblies 85. Thus, the threaded rod 74 is preferably located through the left retaining plate 76, the left hollow shaft member 70, the middle of the shaft tube 60, the threaded plug 68, the right hollow shaft member 72, and further through the right retaining plate 78.

A thrust bearing 80 is assembled over a portion of the threaded rod 74 extending exterior to the left retaining plate 76 and right retaining plate 78. Nuts 82, 83 are threadably engaged to ends of the threaded rod 74 exterior to the thrust bearing 80. Nuts 82, 83 are further secured via driven force fit to the threaded rod 74 using a retainer such as spring pins 84. The spring pins 84 can be driven through a side of nuts 82, 83, through the threaded rod 74 and further through the other side of nuts 82, 83 in order to affix the nuts 82, 83 to the threaded rod 74. It is desirable that the ends of the spring pins 84 remain flush to the surface of the nuts 82, 83 in order to accommodate a fit of a tool, such as a socket assembly or automated wrench, without obstruction.

The mounting orientation of the shaft tube 60 in combination with the threaded plug 68, the left hollow shaft member 70, and the right hollow shaft member 72 is preferably designed to allow the lift carriage 14 to move a distance from a center point in either direction axially along the thread rod 74. In a preferred embodiment, the interior end 86 of the left hollow shaft member 70 and the interior end 88 of the right hollow shaft member 72 are mounted approximately three inches from a left end 90 of the threaded plug 68 and a right end 92 of the threaded plug 68, respectively. Thus, in the described configuration, the lift carriage 14 may achieve a maximum three inch lateral movement from center when either nut 82 or 83 is rotated.

Lateral movement of the lift carriage 14 is preferably generated by turning either nut 82 or 83 which are secured to the threaded rod 74. Hence, turning of the threaded rod 74 will simultaneously generate threaded engagement with the threaded plug 68. This, in effect, will enable the components coupled to the threaded rod 74, such as the left hollow shaft member 70 and the right hollow shaft member 72, to move laterally. Further, the lift carriage 14 will translate laterally, because it, too, is coupled to the left hollow shaft member 70 and the right hollow shaft member 72 via the left retaining plate 76 and a right retaining plate 78. Hence rotating either nut 82 or 83 to engage the threaded rod 74 will, in turn, translate lateral movement to the lift carriage 14.

A description of the main frame assembly 12 in accordance with a preferred embodiment of the invention is described herein. The main frame assembly 12 comprises a left extended vertical support member 94 having a top end 96, a bottom end 98, a front surface 100, a rear surface 102, an inner side surface 104, and an outer side surface 106. The main frame assembly 12 also comprises a right extended vertical support member 108 having a top end 110, a bottom end 112, a front surface 114, a rear surface 116, an inner side surface 118, and an outer side surface 120. The preferred shape of the left extended vertical support member 94 and the right extended vertical support member 108 may include a rectangular design in order to provide sufficient support to the main frame assembly 12 and to enable connection of additional components.

A plurality of cross bar members including, for example, a top forward cross bar member 122 and a top rear cross bar member 124 are affixed to the top ends 96, 110 of the left extended vertical support member 94 and the right extended vertical support member 108 in a rigidly secured fashion. The preferred material of the left extended vertical support member 94, the right extended vertical support member 108, the top forward cross bar member 122, and the top rear cross bar member 124 comprises weldable steel. Thus, one manner is which the cross bar members 122, 124 may be rigidly secured to the vertical support members 94, 108 includes welding.

In accordance with a preferred embodiment, one end of the top forward cross bar member 122 is rigidly secured to the front surface 100 at the top end 96 of left extended vertical support member 94. The other end of the top forward cross bar member 122 is rigidly secured to the front surface 114 at the top end 110 of right extended vertical support member 108. Additionally, one end of the top rear cross bar member 124 is rigidly secured to the rear surface 102 at the top end 96 of left extended vertical support member 94. The other end of the top rear cross bar member 124 is rigidly secured to the rear surface 116 at the top end 110 of right extended vertical support member 108.

The left extended vertical support member 94 and the right extended vertical support member 108 generally rest atop a main cross bar member 126. In order to support the main frame assembly 12, for instance, in a free-standing position, a left forward projecting foot member 136 and a right forward projecting foot member 138 are provided to rigidly connect to the main cross bar member 126. The preferred materials of the main cross bar member 126, the left forward projecting foot member 136, and the right forward projecting foot member 138 include weldable steel material. Mounting plates 139 may be provided at either end of the left forward projecting foot member 136 and right forward projecting foot member 138 and welded thereto. Wheel assemblies 141 such as heavy duty caster assemblies may be further connected to the mounting plates 139 using fasteners 143 such as nut and bolt assemblies. The wheel assemblies may comprise swivel casters and/or locking casters.

In a preferred embodiment, the main cross bar member 126 comprises a left end 128 and a right end 130. The left forward projecting foot member 136 and a right forward projecting foot member 138 are rigidly attached to the left end 128 and the right end 130 of the main cross bar member 126, respectively. Such attachment may include welding the left end 128 to a side surface 140 of the left forward projecting foot member 136 and welding the right end 130 to a side surface 142 of the right forward projecting foot member 138.

An embodiment of the preferred invention includes a mounting plate 132 generally mounted on top of the main cross bar member 126. The mounting plate 132 may be secured to the main cross bar member 126 by a plurality of fasteners such as nut and bolt assemblies 134. A preferred material of the mounting plate 132 includes weldable steel. The bottom end 98 of left extended vertical support member 94 may be rigidly attached to the mounting plate 132. Likewise, the bottom end 112 of right extended vertical support member 108 may be rigidly attached to the mounting plate 132. Such rigid attachment may include, for example, welding the vertical support members 98, 108 to the mounting plate 132.

The lift assembly of the high lift wheel dolly 10 includes a lifting bar member 144. The lifting bar member 144 is driven vertically by a hydraulic cylinder and ram assembly 146 coupled thereto. In a preferred embodiment, the hydraulic cylinder and ram assembly 146 is mounted through the lifting bar member 144. A preferred configuration of the hydraulic cylinder and ram assembly 146 will accommodate a vertical lifting distance of at least forty-two inches. As will be described below, the left extended vertical support member 94 and the right extended vertical support member 108 will provide support to stabilize the lifting bar member 144. Thus, a preferred length of the left extended vertical support member 94 and the right extended vertical support member 108 will also accommodate a vertical lifting distance of at least forty-two inches.

An end 148 of the hydraulic cylinder and ram assembly 146 may be further mounted to the mounting plate 132. Preferably, the end 148 may contain internal threads for receiving a fastener such as a threaded screw. Thus, in a preferred embodiment, a threaded fastener may be utilized to connect the end 148 to the main cross bar member 126 through the mounting plate 132.

The hydraulic cylinder and ram assembly 146 may further contain a hose fitting 153 to receive a connector from an air over hydraulic pump, in order to pressurized hydraulic oil within the hydraulic cylinder and ram assembly 146 to drive the hydraulic cylinder accordingly. The air over hydraulic pump may be further connected to a compressed air source to supply compressed air, for instance, located in an automotive repair shop. In the preferred embodiment, the air over hydraulic pump is mounted directly to the main frame assembly 12, for instance, on an air pump mounting bracket 133 located on the mounting plate 132.

As the lifting bar member 144 is driven vertically by the hydraulic cylinder and ram assembly 146, it is desirable to stabilize the ends of the lifting bar member 144 along the left extended vertical support member 94 and the right extended vertical support member 108. In a preferred embodiment of the invention, the lifting bar member 144 includes a left end 150 and a right end 152. A plurality of U-shaped support plates 153, 155 are provided to facilitate stabilizing the ends 150, 152 of the lifting bar member 144 and providing additional support the left extended vertical support member 94 and the right extended vertical support member 108.

For example, a left U-shaped plate 153 preferably comprises an inner left support plate 154 provided and rigidly secured to the left end 150 of the lifting bar member 144. The inner left support plate 154 is generally designed to traverse the inner side surface 104 of the left extended vertical support member 94 as the lifting bar member 144 is vertically driven by the hydraulic cylinder and ram assembly 146. The inner left support plate 154 is preferably designed such that it is wider than the inner side surface 104 in order to accommodate and retain a roller 162, for instance, generally along the front surface 100 and the rear surface 102 of the left extended vertical support member 94.

An outer left support plate 156 may also be provided along the outer side surface 106 of the left extended vertical support member 94 opposite the inner left support plate 154. The outer left support plate 156 is preferably designed to be wider than the outer side surface 106 in order to accommodate and retain the roller 162, for instance, generally along the front surface 100 and the rear surface 102 of the left extended vertical support member 94.

The roller 162 is located between the inner left support plate 154 and the outer left support plate 156. In a preferred embodiment, the roller width is generally equivalent to the width of the front surface 100 and/or the rear surface 102 of the left extended vertical support member 94. It is desirable to retain the roller 162 between each support plate 154, 156, for instance, using a rigid connection or fastener extending through each support plate 154, 156 and the roller 162. An additional method for retaining the spacer may include extending a weldable rod through the spacer and each support plate 154, 156 and welding the rod ends to the support plates 154, 156.

In a preferred embodiment, the roller 162 is placed between the support plates 154, 156 along the front surface 100 and along the rear surface 102 of the left extended vertical support member 94. Once the outer left support plate 156 is coupled to the inner left support plate 154 through the rollers 162, the outer left support plate 156 is generally designed to traverse the outer side surface 106 of the left extended vertical support member 94 as the lifting bar member 144 is vertically driven by the hydraulic cylinder and ram assembly 146.

A similar arrangement is provided along the right extended vertical support member 108. A right U-shaped plate 155 preferably comprises an inner right support plate 158 is provided and rigidly secured to the right end 152 of the lifting bar member 144. The inner right support plate 158 is generally designed to traverse the inner side surface 118 of the right extended vertical support member 108 as the lifting bar member 144 is vertically driven by the hydraulic cylinder and ram assembly 146. The inner right support plate 158 is preferably designed such that it is wider than the inner side surface 118 in order to accommodate and retain the roller 162, for instance, generally along the front surface 114 and the rear surface 116 of the right extended vertical support member 108.

An outer right support plate 160 may also be provided along the outer side surface 120 of the right extended vertical support member 108 opposite the inner right support plate 158. The outer right support plate 160 is preferably designed to be wider than the outer side surface 120 in order to accommodate and retain the roller 162, for instance, generally along the front surface 114 and the rear surface 116 of the right extended vertical support member 108.

The roller 162 is located between the inner right support plate 158 and the outer right support plate 160. In a preferred embodiment, the spacer element width is generally equivalent to the width of the front surface 114 and/or the rear surface 116 of the right extended vertical support member 108. It is desirable to retain the roller 162 between each support plate 158, 160, for instance, using a rigid connection or fastener extending through each support plate 158, 160 and the roller 162. An additional method for retaining the spacer may include extending a weldable rod through the spacer and each support plate 158, 160 and welding the rod ends to the support plates 158, 160.

In a preferred embodiment, the roller 162 is placed between the support plates 158, 160 along the front surface 114 and along the rear surface 116 of the right extended vertical support member 108. Once the outer right support plate 160 is coupled to the inner right support plate 158 through the rollers 162, the outer right support plate 160 is generally designed to traverse the outer side surface 120 of the right extended vertical support member 108 as the lifting bar member 144 is vertically driven by the hydraulic cylinder and ram assembly 146.

The lift carriage 14 is coupled to the main frame assembly 12 preferably along the body portion of the lifting bar member 144. In a preferred embodiment, a left lift carriage support bracket 164 and a right lift carriage support bracket 166 are secured to the outer surface of the shaft tube 60 as shown, for instance, in FIGS. 1 and 3. The preferred design of the left lift carriage support bracket 164 and the right lift carriage support bracket 166 includes an L-shaped design. In one embodiment, the shaft tube 60 is inserted through a portion of the left lift carriage support bracket 164 and the right lift carriage support bracket 166 at one end thereof. The left lift carriage support bracket 164 and the right lift carriage support bracket 166 are generally mounted at the left end 64 and the right end 66 of the shaft tube 60, for instance, by welding the brackets in place to the outer surface of the shaft tube 60.

The left lift carriage support bracket 164 and the right lift carriage support bracket 166 are further coupled at their respective other ends to the body portion of the lifting bar member 144. Preferably the left lift carriage support bracket 164 and the right lift carriage support bracket 166 will be generally mounted towards the left end 150 and the right end 152 of the lifting bar member 144, respectively. A rigid attachment may be provided through welding, for example, the ends of the left lift carriage support bracket 164 and the right lift carriage support bracket 166 to the left end 150 and the right end 152 of the lifting bar member 144, respectively. The aforementioned configuration will drive the lift carriage 14 vertically by the lifting bar member 144 when the hydraulic cylinder and ram assembly 146 is activated.

As previously mentioned, it is further desirable to provide a tilting feature for the high lift wheel dolly 10. To do so, a preferred embodiment may include mounting the bottom cross bar member 30 between the left vertical support member 16 and the right vertical support member 18 at a height level corresponding to the mounted height level of the lifting bar member 144, i.e., the cross bar member 30 is preferably mounted at the same height opposite to the lifting bar member 144. An embodiment of the present invention includes applying a force to the bottom cross bar member 30 to generate a moment force to the lift carriage 14 and around the shaft tube 60.

A forcing screw mechanism 167 is mounted to the lifting bar member 144. The forcing screw mechanism 167 may comprise a disk 168 such as a polymer or nylon material to push against the bottom cross bar member 30 and is preferably mounted to the front face 151 of the lifting bar member 144. A forcing screw assembly 170 may be connected to the disk 168 to adjust the disk 168 axially and against the bottom cross bar member 30. Movement against the bottom cross bar member 30 by the disk 168 will cause the bottom cross bar member to translate the force to the lift carriage 14. The left hollow shaft member 70 and the right hollow shaft member 72 remain slidingly engaged with the shaft tube 60. Thus, the lift carriage 14 will pivot around an axis of the assembled left hollow shaft member 70, the right hollow shaft member 72 and the shaft tube 60.

In a preferred embodiment, the forcing screw assembly 170 is mounted through the back face 149 of the lifting bar member 144 to connect to the disk 168 through the front face 151 of the lifting bar member 144. The forcing screw assembly 170 may additionally be provided with an assembly head 172 for turning the forcing screw such as a hexagonal socket head or wrench fitting.

Although an example of the high lift wheel dolly 10 is shown supporting and/or lifting a tire 59, it will be appreciated that other components can be supported and/or lifted by the present invention. Also, although the lateral movement described herein includes a preferred maximum distance of three inches left or right from center reference point, it is possible to adjust this maximum distance as deemed necessary. Furthermore, it may be useful to adjust the left extended vertical support member 94, the right extended vertical support member 108, and/or the hydraulic cylinder and ram assembly 146 in order to allow various vertical lifting heights of the lift carriage 14.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

1. An apparatus for supporting and lifting a component comprising:
a main frame assembly;
a lift carriage slidably connected to the main frame assembly, wherein the lift carriage is laterally adjustable with respect to the main frame assembly; and
a hydraulic cylinder and ram assembly located on the main frame assembly and further coupled to the lift carriage.

2. The apparatus of claim 1, wherein the lift carriage is tiltably adjustable with respect to the main frame assembly.

3. The apparatus of claim 1, wherein the hydraulic cylinder and ram assembly will accommodate a vertical lifting distance of at least forty-two inches.

4. The apparatus of claim 1, wherein the main frame assembly further comprises:
a first vertical support member having an inner surface, an outer surface, a bottom end and a top end;
a second vertical support member having an inner surface, an outer surface, a bottom end and a top end;
at least one top cross bar member connecting the top end of the first vertical support member with the top end of the second vertical support member;
a bottom cross bar member having a first end and a second end wherein the bottom cross bar member is rigidly coupled to the bottom end of the first vertical support member and the bottom end of the second vertical support member;
a first forward projecting member rigidly attached to the first end of the bottom cross bar member;
a second forward projecting member rigidly attached to the second end of the bottom cross bar member; and
a lifting bar member have a first end and a second end, wherein the lifting bar is positioned between the two vertical support members, wherein further the hydraulic cylinder and ram assembly is coupled to the lifting bar and the bottom cross bar member to provide vertical movement to the lifting bar.

5. The apparatus of claim 4, further comprising:
a plurality of support plates coupled to the first end and the second end of the lifting bar member wherein the support plates generally traverse the first vertical support member and the second vertical support member when the lifting bar is vertically moved.

6. The apparatus of claim 4, further comprising:
a plurality of wheels attached to the first forward projecting member and the second forward projecting member to support the main frame assembly.

7. The apparatus of claim 1, wherein the lift carriage further comprises:
a first vertical support member having an inner surface, an outer surface, a bottom end and a top end;
a second vertical support member having an inner surface, an outer surface, a bottom end and a top end;
a top cross bar member connecting the top end of the first vertical support member with the top end of the second vertical support member;
a bottom cross bar member having a first end and a second end wherein the bottom cross bar member is rigidly coupled to the inner surface of the first vertical support member and an inner surface of the second vertical support member;
a first forward projecting member coupled to a bottom end of the first vertical support member; and
a second forward projecting member coupled to a bottom end of the second vertical support member.

8. The apparatus of claim 7, wherein the first forward projecting member and the second forward projecting comprise:
tubular post members.

9. The apparatus of claim 8, further comprising:
at least one of sleeve inserted over the tubular post members.

10. The apparatus of claim 9, further comprising:
a plurality of sleeved segments inserted over the tubular post members.

11. The apparatus of claim 10, wherein the plurality of sleeved segments is retained upon the tubular post member by a fastener assembly.

12. The apparatus of claim 11, further comprising:
a hollow shaft tube having a first end and a second end;
a first hollow shaft member having a first end and a second end, wherein the first end of the first hollow shaft member is inserted into the first end of the hollow shaft tube;
a second hollow shaft member having a first end and a second end, wherein the first end of the second hollow shaft member is inserted into the second end of the hollow shaft tube;
a threaded plug located within the hollow shaft tube;
a first retaining plate located against the second end of the first hollow shaft member;
a second retaining plate located against the second end of the second hollow shaft member; and
a threaded rod inserted through the hollow shaft tube, the first hollow shaft member, the second hollow shaft member, the first retaining plate, the second retaining plate, and further threaded through the threaded plug, wherein the threaded rod extends past an end of the first retaining plate, and an end of the second retaining plate.

13. The apparatus of claim 12, further comprising:
a thrust bearing assembly located on each end of the threaded rod; and
a nut assembly located on each end of the threaded rod exterior to each thrust bearing assembly.

14. The apparatus of claim 13, wherein each nut assembly is retained on the threaded rod by spring pin inserted through each nut and the threaded rod.

15. The apparatus of claim 12, further comprising:
a first support bracket coupled to the first end of the hollow shaft tube and further coupled to a general location of the first end of the lifting bar member; and
a second support bracket coupled to the second end of the hollow shaft tube and further coupled to a general location of the second end of the lifting bar member.

16. The apparatus of claim 15, wherein the first support bracket and the second support bracket are generally L-shaped.

17. The apparatus of claim 13, further comprising:
a forcing screw mechanism located on the lifting bar member, the forcing screw mechanism having an end thereof capable of abutting against a surface of the bottom cross bar member to generate a moment around an axis of the shaft tube.

18. An apparatus for supporting and lifting a component comprising:
a main frame assembly;
a lift carriage connected to the main frame assembly wherein the lift carriage is tiltably and laterally adjustable with respect to the main frame assembly;
a hydraulic cylinder and ram assembly located on the main frame assembly and further coupled to the lift carriage; and
a plurality of wheels to support the main frame assembly.

19. A system for supporting and lifting a component comprising:
first means for supporting;
second means for supporting a component, the second supporting means slideably connected to the first supporting means, wherein the second supporting means is laterally adjustable with respect to the first supporting means; and
means for lifting the second supporting means.

20. The system of claim 19, further comprising:
first means for tilting the second supporting means.

21. The system of claim 20, further comprising:
means for providing lateral movement to the supporting means.

22. The system of claim 19, wherein the lifting means is generally located on the first supporting means and the lifting means is further coupled to the second supporting means.

23. A system for supporting and lifting a component comprising:
means for supporting the component;
means for tilting the supporting means;
means for providing lateral movement to the supporting means;
means for lifting the supporting means; and
means for supporting the lifting means.

24. A method for supporting and vertically lifting a component comprising:
providing a hydraulic cylinder and ram assembly on a main frame assembly;
providing a lift carriage to support a component;
pivotally connecting the lift carriage to the main frame assembly; and
coupling the hydraulic cylinder and ram assembly to the lift carriage.

25. The method of claim 24, further comprising:
attaching a plurality of wheels to the main frame assembly.
